(19) United States
(12) Patent Application Publication
(10) Pub. No.: US 2026/0074963 A1
(43) Pub. Date: Mar. 12, 2026

(54) COMMUNICATION CONTROL METHOD AND USER EQUIPMENT

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/384,778

(22) Filed: Nov. 10, 2025

Related U.S. Application Data
(63) Continuation of application No. PCT/JP2024/017461, filed on May 10, 2024.

(30) Foreign Application Priority Data
May 11, 2023 (JP) 2023-078819

(51) Int. Cl. H04L 41/16; H04L 41/14

(52) U.S. Cl. CPC H04L 41/16; H04L 41/145

(57) ABSTRACT

The present disclosure relates to a communication control method in a mobile communication system. The communication control method includes managing, by a model management entity, model change information indicating whether model training has been performed on a trained first AI/ML model.

### RELATED APPLICATIONS

The present application is a continuation based on PCT Application No. PCT/JP2024/017461, filed on May 10, 2024, which claims the benefit of Japanese Patent Application No. 2023-078819 filed on May 11, 2023. The content of which is incorporated by reference herein in their entirety.

### TECHNICAL FIELD

The present disclosure relates to a communication control method and a user equipment.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-Patent Document 1: 3GPP Contribution RP-213599, “New SI. Study on Artificial Intelligence (AI)/Machine Learning (ML) for NR Air Interface”

### SUMMARY

A communication control method according to a first aspect is a communication control method in a mobile communication system. The communication control method includes managing, by a model management entity, model change information indicating whether re-training has been performed on a trained first AI/ML model.

A user equipment according to a second aspect includes a controller configured to turn on, when re-training is performed on a trained first AI/ML model, model change information indicating whether re-training has been performed on the first AI/ML model.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIGS. 9A and 9B are diagrams illustrating an example of reducing CSI-RSs according to the first embodiment.

FIG. 10 is a diagram illustrating an operation example according to the first embodiment.

FIG. 11 is a diagram illustrating an arrangement example of functional blocks of the AI/ML technology according to the first embodiment.

FIG. 12 is a diagram illustrating an arrangement example of functional blocks of the AI/ML technology according to the first embodiment.

FIG. 13 is a diagram illustrating an arrangement example of functional blocks of the AI/ML technology according to the first embodiment.

FIG. 14 is a diagram illustrating an operation example according to the first embodiment.

FIG. 15 is a diagram illustrating an example of a configuration message according to the first embodiment.

FIG. 16 is a diagram illustrating a configuration example of a mobile communication system 1 according to the first embodiment.

FIG. 17 is a diagram illustrating an operation example according to the first embodiment.

FIG. 18 is a diagram illustrating an operation example according to a second embodiment.

FIG. 19 is a diagram illustrating an operation example according to a third embodiment.

### DESCRIPTION OF EMBODIMENTS

The present disclosure aims to appropriately manage an AI/ML model.

### First Embodiment

A mobile communication system according to a first embodiment will be described with reference to the drawings. In the description of the drawings, the same or similar parts are denoted by the same or similar reference signs.

### Configuration of Mobile Communication System

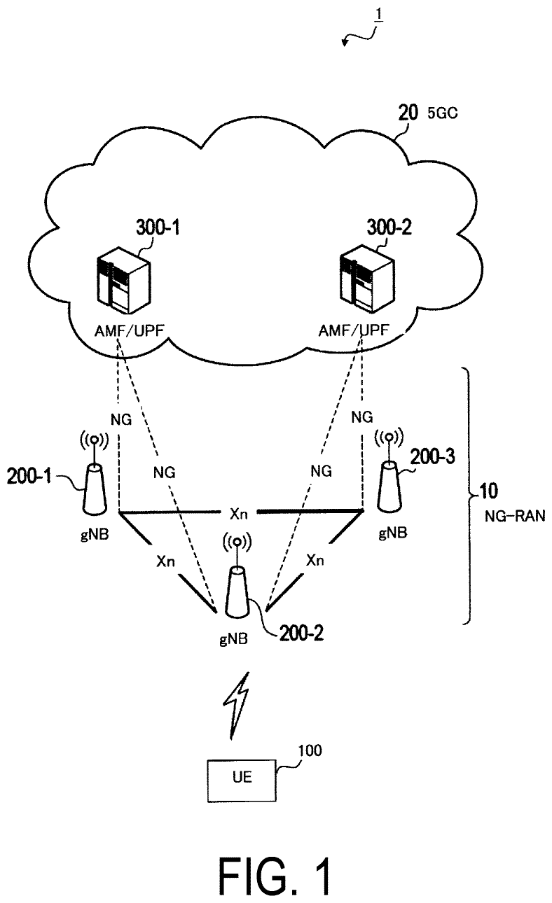

A configuration of a mobile communication system according to a first embodiment will be described. FIG. 1 is a diagram illustrating a configuration example of a mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

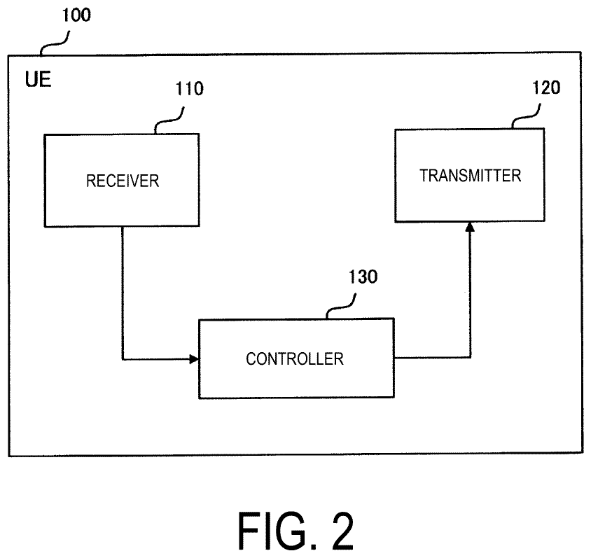

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

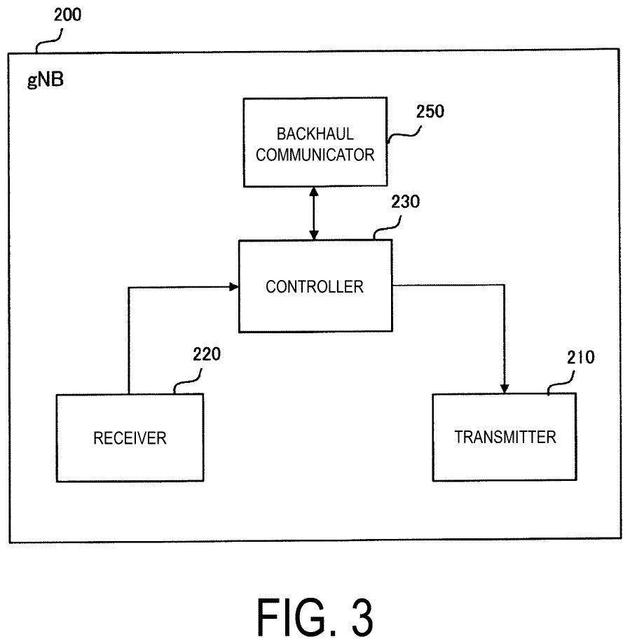

FIG. 3 is a diagram illustrating a configuration example of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

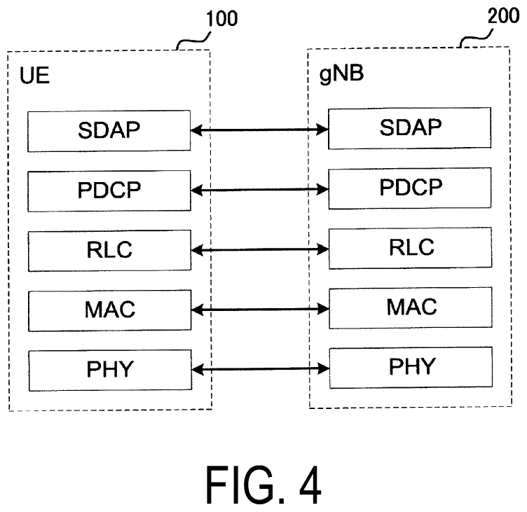

FIG. 4 is a diagram illustrating a configuration example of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. Cyclic redundancy code (CRC) parity bits scrambled by the RNTI are added to the DCI transmitted from the gNB 200.

In NR, the UE 100 can use a bandwidth narrower than a system bandwidth (i.e., a cell bandwidth). The gNB 200 configures a bandwidth portion (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the receiving side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

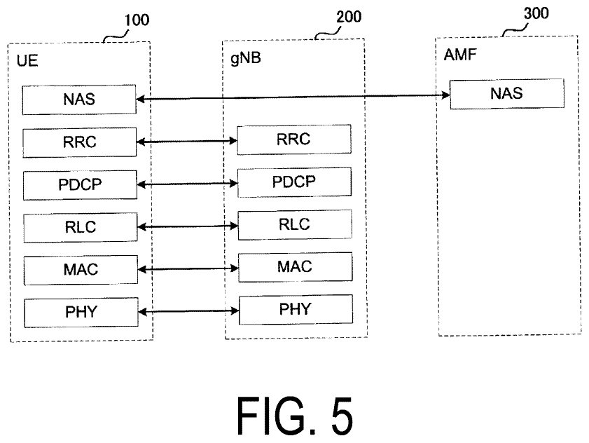

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer and the like other than the protocol of the radio interface. A layer lower than the NAS is referred to as an Access Stratum (AS).

### AI/ML Technology

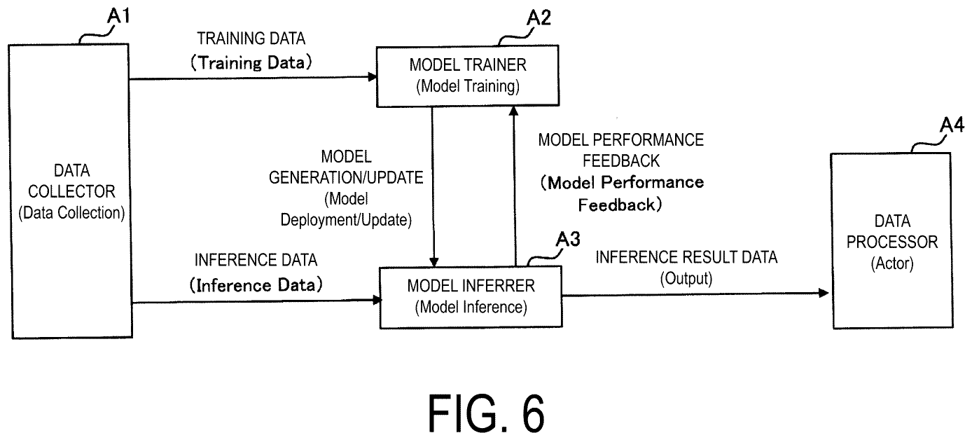

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to the process of collecting data at a network node, a management entity, or the UE 100, for example, to train AI/ML models, perform data analysis, and inference. Based on the data collected by the data collector A1, the training of the AI/ML model and the inference of the AI/ML model in the subsequent stage are performed. The “AI/N model” is, for example, a data-driven algorithm to which an AI/ML technology is applied to generate a series of outputs based on a series of inputs. Hereinafter, the “model” and the “AI/ML model” may be used interchangeably.

The model trainer A2 performs model training. Specifically, the model trainer A2 optimizes parameters of the training model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although the supervised learning will be described hereinafter, unsupervised learning may be applied as the machine learning. The reinforcement learning may be applied as the machine learning. In this way, the process of training an AI/N model (by training the relationship between input and output) in a data-driven manner and acquiring a trained AI/ML model is called, for example, AI/N model training. Hereinafter, the “AI/ML model training” may be referred to as a “model training”. The trained AI/ML model may be referred to as a “trained model”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. This process of using a trained AI/ML model to generate a series of outputs based on a series of inputs is called AI/ML model inference. Hereinafter, the “AI/ML model inference” may be referred to as “model inference”.

The data processor A4 receives the inference result data and performs processing that utilizes the inference result data.

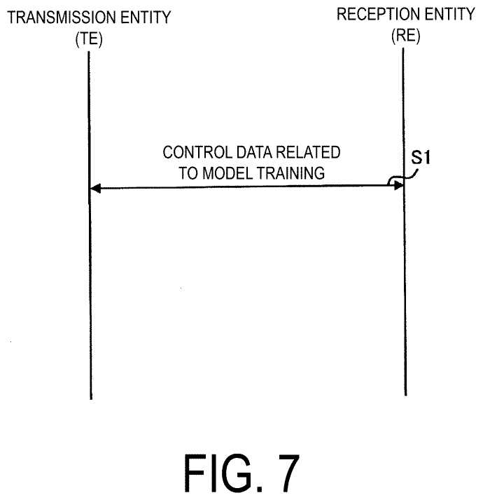

FIG. 7 is a diagram illustrating an operation example in the AI/ML technology according to the first embodiment.

A transmission entity TE is, for example, an entity in which machine learning is performed. The transmission entity TE may derive a trained model by performing machine learning. Then, the transmission entity TE uses the trained model to generate inference result data as an inference result. The transmission entity TE transmits the inference result data to a reception entity RE.

The reception entity RE is, for example, an entity in which no machine learning is performed. The reception entity RE receives the inference result data transmitted from the transmission entity TE. The reception entity RE performs various processing operations by using the inference result data.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The control data may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement” Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

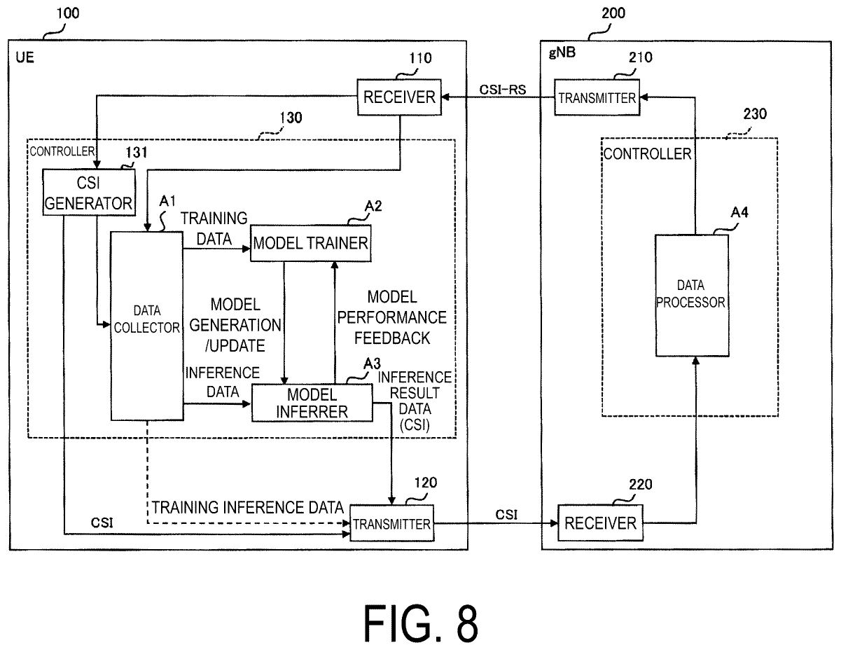

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, a CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

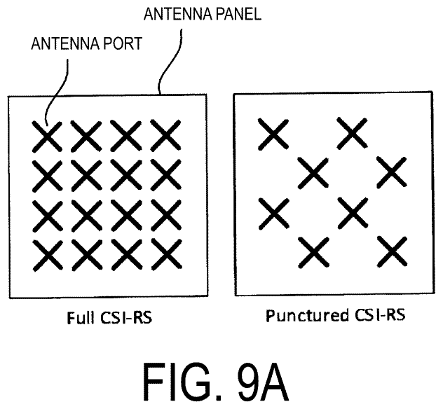

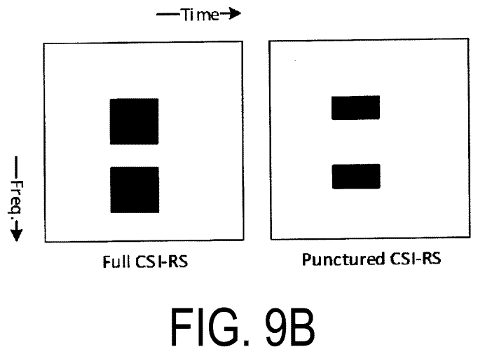

FIGS. 9A and 9B are diagrams illustrating an example of reducing CSI-RSs according to the first embodiment.

FIG. 9A illustrates an example in which the CSI-RSs are reduced by reducing the number of antenna ports for transmitting the CSI-RSs. For example, the gNB 200 may perform the following processing. In other words, the gNB 200 transmits the CSI-RS from all antenna ports of the antenna panel in a mode in which the UE 100 performs the model training (which may hereinafter be referred to as a “training mode”). On the other hand, in the mode in which the UE 100 performs model inference (which may hereinafter be referred to as an “inference mode”), the gNB 200 reduces the number of antenna ports for transmitting the CSI-RS, and transmits the CSI-RS from half the antenna ports of the antenna panel. This enables reduced overhead and improved utilization efficiency for the antenna ports, and allows a reduction effect for power consumption to be produced. Note that the antenna port is an example of the resource.

On the other hand, FIG. 9B illustrates an example in which the gNB 200 reduces the number of radio resources used to transmit the CSI-RS, specifically, the number of time-frequency resources. For example, the gNB 200 may perform the following processing. In other words, when the UE 100 is in the training mode, the gNB 200 transmits the CSI-RS by using predetermined time-frequency resources. On the other hand, when the UE 100 is in the inference mode, the gNB 200 transmits the CSI-RS using time-frequency resources the amount of which is smaller than that of the predetermined time-frequency resources. This enables reduced overhead and improved utilization efficiency for the radio resources, and allows a reduction effect for power consumption to be produced.

As illustrated in FIGS. 9A and 9B, the gNB 200 transmits the full CSI-RS using a predetermined amount of first resources, and transmits the partial CSI-RS using second resources that are less than the first resources.

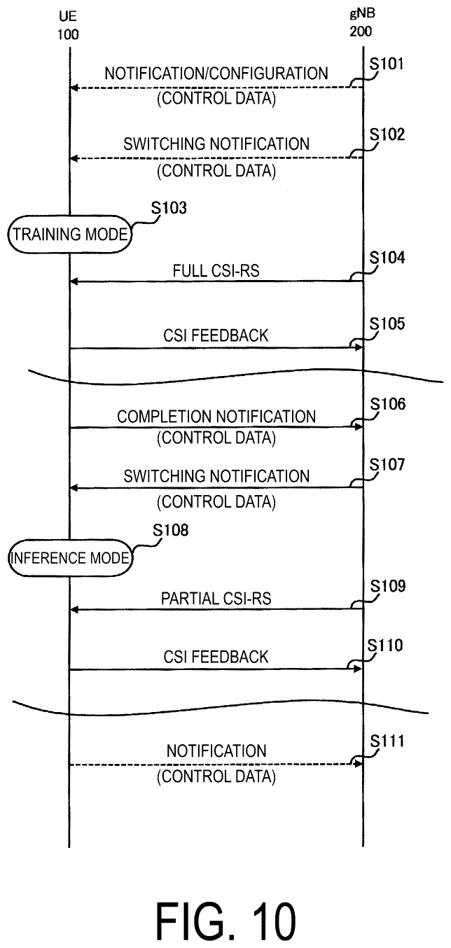

FIG. 10 illustrates an operation example in the “CSI feedback enhancement” according to the first embodiment.

As illustrated in FIG. 10, in step S101, the gNB 200 may notify the UE 100 of or configure for the UE 100, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back), to the gNB 200 as inference result data, the CSI, which is an inference result. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 10, the training data is “(full) CSI-RS” and “CSI”, and the inference data is “(partial) CSI-RS”. Hereinafter, the training data and/or the inference data may be referred to as a “dataset”.

In the “CSI feedback enhancement”, in addition to the “CSI-RS” and the “CSI”, for example, the following data and/or information may be used as the dataset.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)
   What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits, to the UE 100 as the control data, the data type information used as a dataset. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The ULE 100 determines, for example, a beam with the best reception quality as the optimum beam.

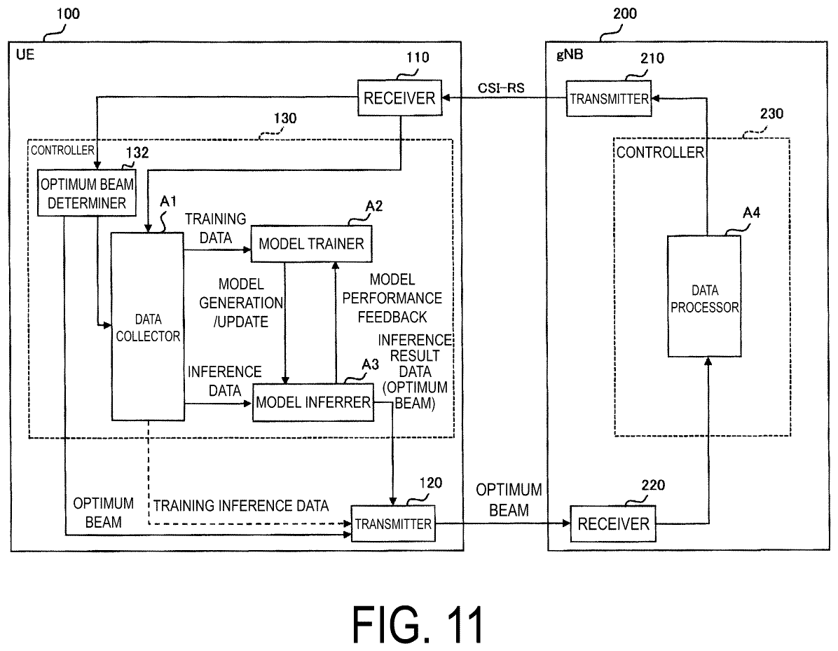

FIG. 11 is a diagram illustrating an arrangement example of the functional blocks in the “beam management”. In the example of the “beam management” illustrated in FIG. 11, the controller 130 of the UE 100 includes the data collector A1, the model trainer A2, and the model inferrer A3. On the other hand, the controller 230 of the gNB 200 includes the data processor A4. In other words, FIG. 11 illustrates an example in which the UE 100 performs model training and model inference. FIG. 11 illustrates the example in which the transmission entity TE is the UE 100 and the reception entity RE is the gNB 200.

As illustrated in FIG. 11, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 10.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, the following data and/or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER (BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)
   The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit, to the UE 100 as the control data, the data type information used as a dataset. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

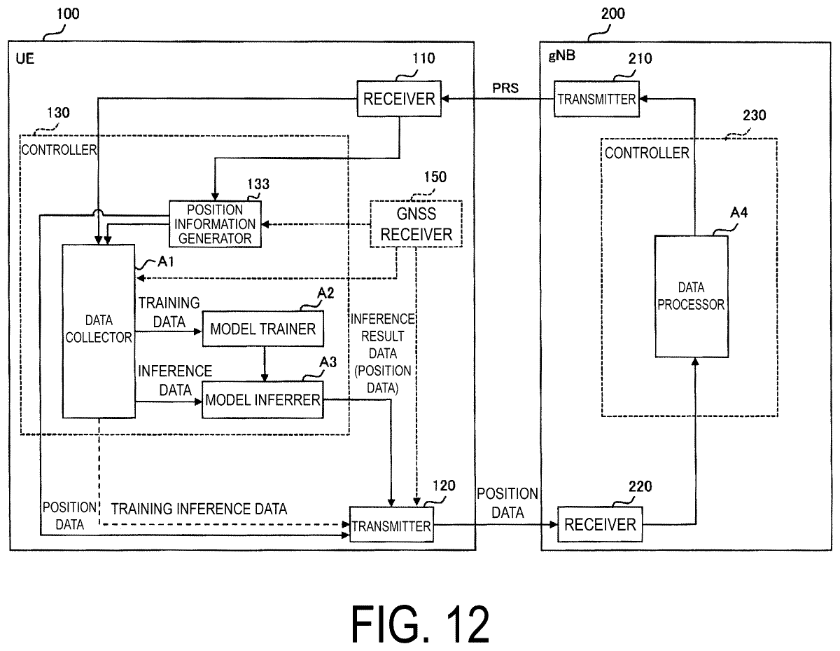

FIG. 12 is a diagram illustrating an arrangement example of the functional blocks in the “positioning accuracy enhancement”. In the example of the “positioning accuracy enhancement” illustrated in FIG. 12, the controller 130 of the UE 100 includes the data collector A1, the model trainer A2, and the model inferrer A3. On the other hand, the controller 230 of the gNB 200 includes the data processor A4. In other words, FIG. 12 illustrates an example in which the UE 100 perform model training and model inference. FIG. 12 illustrates an example in which the transmission entity TE is the UE 100 and the reception entity RE is the gNB 200.

As illustrated in FIG. 12, the UE 100 includes a position information generator 133. The UE 100 may include a Global Navigation Satellite System (GNSS) receiver 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS receiver 150 and generate the position data of the UE 100 based on the GNSS signal.

Note that, as with the full CSI-RS, the gNB 200 transmits the full PRS using a predetermined amount of first resources (for example, all antenna ports as illustrated in FIG. 9A or a predetermined amount of time-frequency resources as illustrated in FIG. 9B). Further, as with the partial CSI-RS, the gNB 200 transmits the partial PRS by using the second resource (for example, half the antenna ports in the antenna panel as illustrated in FIG. 9A, or half the predetermined amount of time-frequency resources as illustrated in FIG. 9B) having the smaller amount of resources than the first resources.

The full GNSS signal may be a GNSS signal temporally continuously received by the GNSS receiver 150. The partial GNSS signal may be a GNSS signal intermittently received by the GNSS receiver 150. In other words, a predetermined amount of first resources may be used for the full GNSS signal, and the second resources the amount of which is smaller than that of the first resources may be used for the partial GNSS signal.

An operation example in the “positioning accuracy enhancement” can be implemented by replacing the “full CSI-RS” with the “full PRS”, the “partial CSI-RS” with the “partial PRS”, and the “CSI feedback” with the “position data” in FIG. 10.

In the training mode (step S103), the position information generator 133 generates the position data of the UE 100 based on the full PRS received from the gNB 200. The position information generator 133 may receive a full GNSS signal received by the GNSS receiver 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS receiver 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, the following data and/or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (registered trademark), or Bluetooth (registered trademark)
(Z7) Moving speed of the UE 100 (the moving speed may be measured by the GNSS receiver 150. The moving speed may be measured by a speed sensor in the UE 100) The UE 100 may transmit capability information as the control data to the gNB 200, the capability information indicating which type of input data the UE 100 can handle in the machine learning. The capability information may include any information or data from among (Z1) to (Z7). Aside from the training data and the inference data, the capability information may include any information or data from among (Z1) to (Z7). The gNB 200 may transmit, to the UE 100 as the control data, the data type information used as a dataset. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

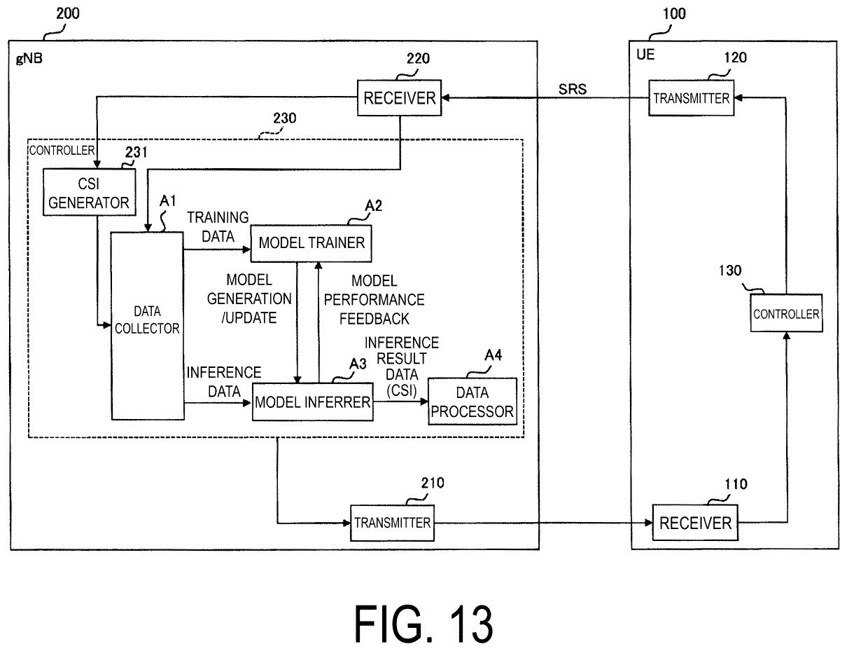

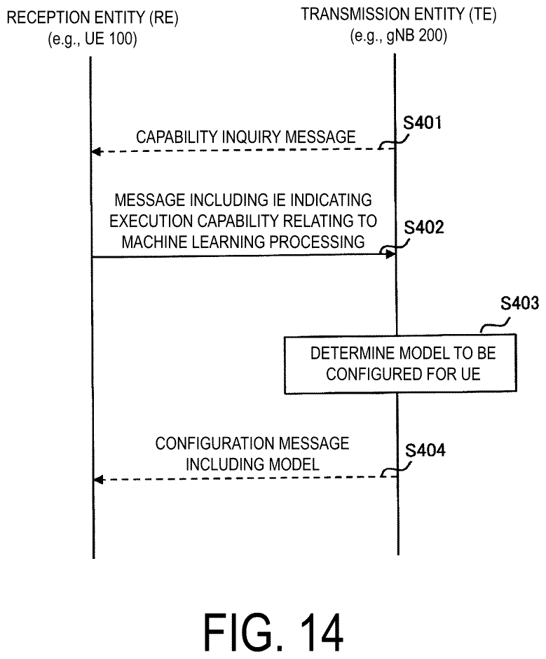

FIG. 13 is a diagram illustrating another arrangement example of the “CSI feedback enhancement” according to the first embodiment. FIG. 13 illustrates an example in which the gNB 200 includes the data collector A1, the model trainer A2, the model inferrer A3, and the data processor A4. In other words, FIG. 13 illustrates an example in which the gNB 200 performs model training and model inference. FIG. 14 illustrates an example in which the transmission entity TE is the gNB 200 and the reception entity RE is the UE 100.

FIG. 13 illustrates an example in which the AI/MWL technology is introduced into CSI estimation performed by a gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

### (1.5) Model Transfer Example

In (1.1) to (1.4), the arrangement example of the functional blocks of the AI/ML technology has been described. Model transfer will be described below. The model to be transferred may be a trained model used in the model inference. The model may be an untrained model used in the model training (or a model being trained).

### (1.6.1) First Operation Pattern Relating to Model Transfer

FIG. 14 is a diagram illustrating an operation example of a first operation pattern relating to model transfer according to the first embodiment. In the example illustrated in FIG. 14, the reception entity RE is mainly described as the UE 100. However, the reception entity RE may be the gNB 200 or AMF 300. In the example illustrated in FIG. 14, the transmission entity TE is mainly described as the gNB 200. However, the transmission entity TE may be the UE 100 or AMF 300.

As illustrated in FIG. 14, in step S401, the gNB 200 transmits, to the UE 100, a capability inquiry message for requesting transmission of the message including the information element (IE) indicating the execution capability relating to the machine learning processing. The UE 100 receives the capability inquiry message. However, the gNB 200 may transmit the capability inquiry message when performing the machine learning processing (when determining to perform the machine learning process).

In step S402, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (e.g., a “UE A1 Capability” message or the like). Alternatively, the transmission entity TE may be the AMF 300 and the message may be a NAS message. Alternatively, when a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported. The information element may be an information element indicating the time (response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing. The information element may be an information element indicating the processing capacity of the learning processing.

In step S403, the gNB 200 determines a model to be configured (deployed) for the UE 100 based on the information element included in the message received in step S402.

In step S404, the gNB 200 transmits, to the UE 100, a message including the model determined in step S403. The UE 100 receives the message and performs the machine learning processing (i.e., model training processing and/or model inference processing) using the model included in the message. A specific example of step S404 will be described in a second operation pattern below.

### (1.6.2) Second Operation Pattern Relating to Model Transfer

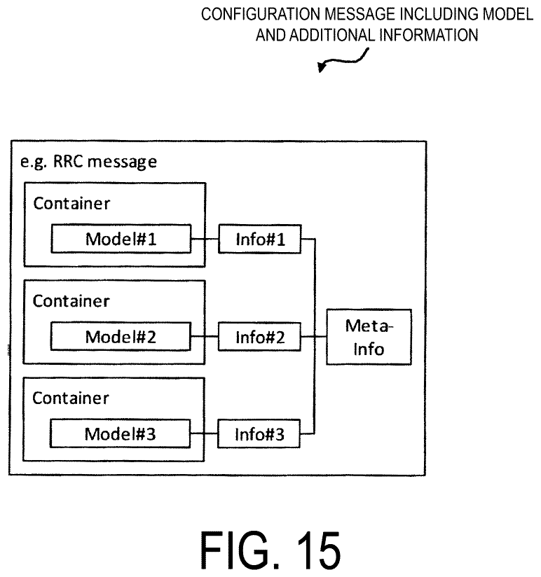

FIG. 15 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. Alternatively, when a new layer for performing or controlling the machine learning processing (AI/ML processing) is defined, the message may be a message of the new layer.

In the example of FIG. 15, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (2) Communication Control Method According to First Embodiment

A communication control method according to the first embodiment will be described.

Currently, 3GPP is discussing model IDs in the AI/ML model. Specifically, in 3GPP, discussions are being conducted under the assumption that the model ID in the AI/ML model after re-training should be identified.

Here, the following case is assumed. That is, the transmission entity TE performs model inference using a trained model A. Thereafter, the transmission entity TE determines that the inference results of the trained model A deviate compared to the results obtained by a legacy operation (operation that obtains inference results without using an AI/ML model), and performs model training (i.e., re-training; hereinafter, model training of a trained model may be referred to as “re-training”) using the trained model A to create a new trained model A′.

In such a case, it is assumed that the trained model A before re-training and the trained model A′ after re-training will obtain different inference result data. Therefore, the two trained models A and A′ should be managed with different model IDs.

However, even when two trained models A and A′ are managed with different model IDs, unless the relationship between the two trained models A and A′ is managed, such as by showing that the trained model A′ is a model after training of the trained model A, they will simply be managed as different trained models.

Therefore, the first embodiment aims to enable appropriate management of an AI/ML model even when re-training is performed on a trained AI/IL model.

In particular, 3GPP is currently discussing life cycle management (LCM) (hereinafter sometimes referred to as “LCM”) for the AI/ML model. LCM is, for example, managing the life cycle of an AI/ML model, from its generation to its management, operation, and deletion. By appropriately managing the AI/ML model, it is possible to take an appropriate approach to LCM.

Therefore, in the first embodiment, the model management entity manages model change information indicating whether model training has been performed on a trained first AI/IL model.

In this way, in the first embodiment, since the AI/ML model is managed using model change information, the mobile communication system 1 can easily ascertain whether re-training has been performed on the AI/ML model. Therefore, it becomes possible to appropriately manage the AI/ML model.

### (2.1) Configuration Example of Mobile Communication System 1 According to First Embodiment

A configuration example of the mobile communication system 1 according to the first embodiment will be described. The model management entity will be mainly described herein.

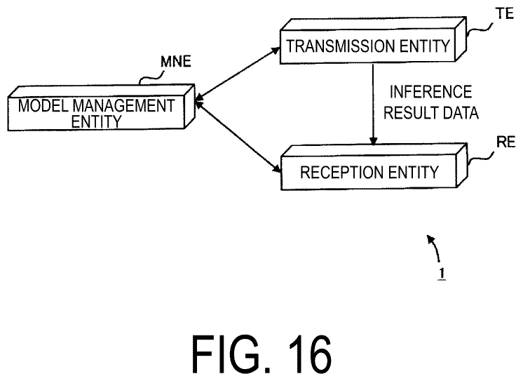

FIG. 16 is a diagram illustrating a configuration example of the mobile communication system 1 according to the first embodiment.

As illustrated in FIG. 16, the mobile communication system 1 includes a transmission entity TE, a reception entity RE, and a model management entity MNE.

As described above, the transmission entity TE is an entity that, for example, performs model inference using a trained model, generates inference result data, and transmits the inference result data to the reception entity RE. In the first embodiment, the transmission entity TE re-trains the trained model.

As mentioned above, the reception entity RE is, for example, an entity that receives the inference result data transmitted from the transmission entity TE. The reception entity RE can use the inference result data to perform various processing operations.

In the first embodiment, an example in which the transmission entity TE is the UE 100 and the reception entity RE is the gNB 200 will be mainly described, but the present disclosure is not limited thereto. For example, the transmission entity TE may be the gNB 200, and in this case, the reception entity RE may be a core network apparatus or an Over The Top (OTT) server apparatus. When the transmission entity TE is the UE 100, for example, the reception entity RE may be a core network apparatus or an OTT server apparatus. The OTT server apparatus is, for example, an apparatus that exists outside the mobile communication system 1 and provides various content services, such as video distribution, to the UE 100.

The model management entity MINE is, for example, an entity that manages the AI/ML model used in the mobile communication system 1. The model management entity MINE holds a model management list in a memory, and in the model management list, each AI/ML model is identified by a model ID. In the first embodiment, the model management entity MNE may assign a model ID (or model identification information; hereinafter, sometimes referred to as a “model ID”) to an AI/ML model.

The model ID may be any identification information that at least distinguishes the AI/ML model from other AI/ML models. The model ID may be a globally identifying information. That is, the model ID may be identification information that is unique among Public Land Mobile Networks (PLMNs). Therefore, the model ID may include a PLMN ID. Alternatively, the model ID may be identification information that is unique among Non-public networks (NPNs). Therefore, the model ID may include an NPN ID. The NPN ID may be a PLMN ID and a Closed Access Group ID (CAG), or a PLMN ID and a Network ID (NID). Alternatively, the model ID may include a global gNB ID that can globally identify the gNB 200. Alternatively, the model ID may include an NR Cell Global Identifier (NCGI) that can globally identify NR cells.

In the first embodiment, the model management entity MINE manages whether a trained model has been re-trained. The model management entity MNE may use model change information to perform this management.

The model change information may be information indicating whether a trained AI/ML model has been re-trained (e.g., trained information). Alternatively, the model change information may be information indicating whether a trained AI/ML model has been changed by re-training the model. The model change information may be represented as one-bit flag information. Alternatively, the model change information may be represented by a plurality of bits and incremented each time re-training is performed.

In the following, the model change information is described as one-bit flag information. In this case, the model change information being on indicates that re-training has been performed on the trained AI/ML model, and the model change information being off (or cleared) indicates that re-training has not been performed on the trained AI/ML model, but on and off may have the opposite meanings. The flag information may indicate a toggle state. For example, when the initial value of the flag information is off, it will be turned on at the first training, turned off again at the second training, and turned off again at the third training. Thereafter, each time training is performed, on and off is switched.

The model change information may be included in a model ID for identifying the AI/ML model. That is, the model change information may be added to a part of the model ID. Alternatively, the model change information may be included in the additional information (FIG. 15) included in the configuration message. Specifically, the model change information may be included in the individual additional information (Info) added to the corresponding AI/ML model. Alternatively, the model change information may be included in the AI/ML model. Specifically, the model change information may be included in the model body of the AI/ML model. The model change information may be included in the model data of the AI/ML model.

The model management entity MNE may be the gNB 200. The model management entity MINE may be a core network apparatus. The model management entity MNE may be an OTT server apparatus. Even when the reception entity RE is the gNB 200, the model management entity MINE may be the gNB 200. In this case, the gNB 200 has the function of the reception entity RE and the function of the model management entity MNE.

### (2.2) Operation Example According to First Embodiment

An operation example according to the first embodiment will be described.

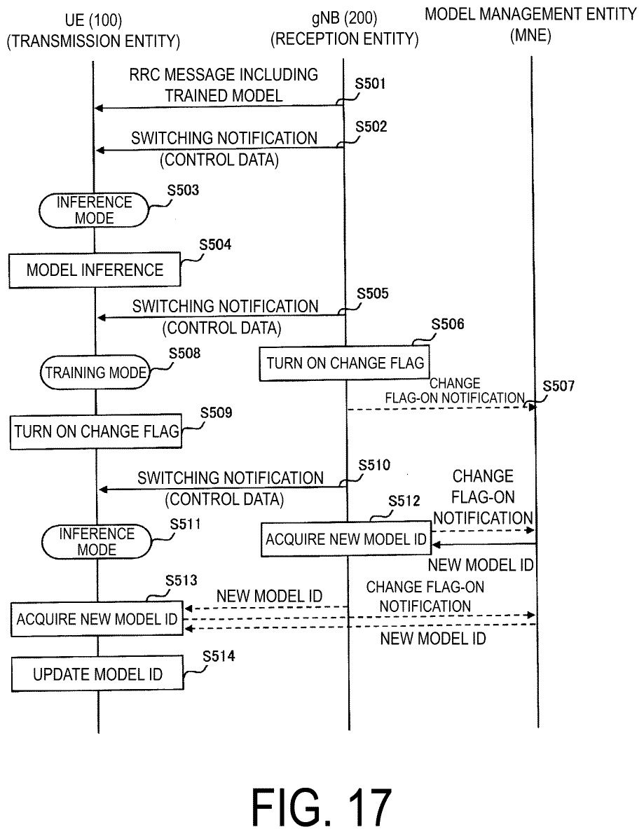

FIG. 17 illustrates an operation example according to the first embodiment. FIG. 17 illustrates an example in which the transmission entity TE is the UE 100, the reception entity RE is the gNB 200, and the model management entity MINE is the core network apparatus. In FIG. 17, processing in the UE 100 may be performed by the controller 130, and processing in the gNB 200 may be performed by the controller 230.

As illustrated in FIG. 17, in step S501, the gNB 200 transmits an RRC message including a trained model(hereinafter described as a trained model A) to the UE 100. The gNB 200 may determine the trained model A to be transmitted based on an information element indicating the execution capability for machine learning processing received from the UE 100 (steps S402 and S403 of FIG. 14). The gNB 200 may transmit the model ID of the trained model A to the UE 100 along with the trained model A. In this case, the gNB 200 may include the model ID of the trained model A in the individual additional information (Info) and transmit the information (FIG. 15). The UE 100 receives the RRC message.

In step S502, the gNB 200 transmits, to the UE 100, a switching notification for switching from the training mode to the inference mode. The switching notification may include the model ID of the trained model A (step S501) that is to be switched to the inference mode. The UE 100 receives the switching notification.

In step S503, in response to receiving the switching notification, the UE 100 switches to the inference mode.

In step S504, the UE 100 performs model inference on the trained model A received in step S501.

In step S505, the gNB 200 transmits, to the UE 100, a switching notification for switching from the inference mode to the training mode. The switching notification may be a switching notification for starting re-training for the trained model A transmitted in step S501. The switching notification may include the model ID of the trained model A to be switched. The UE 100 receives the switching notification.

In step S506, in response to transmitting the switching notification (step S505), the gNB 200 turns on the model change information of the trained model A.

In step S507, the gNB 200 may transmit, to the model management entity MNE, a change flag-on notification indicating that the model change information has been turned on. The gNB 200 may transmit a change flag-on notification by including a change flag-on notification in a message available between the gNB 200 and the model management entity MNE (an NG message when the model management entity MINE is the AMF 300) and transmitting the message.

In step S508, in response to receiving the switching notification in step S505, the UE 100 switches from the inference mode to the training mode. That is, the UE 100 starts re-training the trained model A.

In step S509, the UE 100 turns on the model change information of the trained model A. Alternatively, the UE 100 may turn on the model change information of the trained model A in response to receiving, from the gNB 200, configuration information indicating that the model change information is to be turned on. The configuration information may be transmitted by being included in the control data. The UE 100 may transmit, to the model management entity MNE, a change flag-on notification indicating that the model change information has been turned on. In this case, the UE 100 may transmit the change flag-on notification to the model management entity MINE using a message available between the UE 100 and the model management entity MINE (e.g., a NAS message when the model management entity MNE is the AMF 300). The change flag-on notification may include the model ID of the trained model A for which the model change information has been turned on.

In step S510, the gNB 200 transmits, to the UE 100, a switching notification for switching from the training mode to the inference mode.

In step S511, in response to receiving the switching notification, the UE 100 ends the re-training of the trained model A and performs model inference on the trained model after the re-training. Since the trained model after re-training is different from the trained model A before re-training, the trained model after re-training will be described below as a trained model A′.

In step S512, the gNB 200 performs a process of acquiring a new model ID for the trained model A′. The gNB 200 may start the process of acquiring a new model ID with the model change information being turned on as a trigger (step S506). The gNB 200 may acquire a new model ID by registering a new trained model with the model management entity MNE.

First, the gNB 200 may acquire a new model ID by transmitting, to the model management entity MNE, a change flag-on notification indicating that model change information has been turned on. In this case, the model change information may include the model ID of the trained model A. As in step S507, the gNB 200 may transmit a change flag-on notification using a message available between the gNB 200 and the model management entity MINE (an NG message when the model management entity MINE is the AMF 300). In response to receiving the change flag-on notification, the model management entity MNE may assign a new model ID to the trained model A′ after re-training the trained model A and transmit the model ID to the gNB 200. At this time, the model management entity MNE may turn on the model change information for the trained model A and add the model ID for the trained model A′ to the model management list.

Second, the gNB 200 may acquire a new model ID by transmitting a model ID acquisition request to the model management entity MNE to request the acquisition of a new model ID. Similarly to the change flag-on notification (step S507), the model ID acquisition request may also be transmitted using a message available between the gNB 200 and the model management entity MNE. The model ID acquisition request may include the model ID of the trained model A before re-training. In response to receiving the model ID acquisition request, the model management entity MINE may assign a new model ID and transmit the model ID to the gNB 200. At this time, the model management entity MNE may turn on the model change information for the trained model A and add the model ID for the trained model A′ to the management list.

Third, the gNB 200 may acquire a new model ID by transmitting the trained model A′ to the model management entity MINE. In this case, the gNB 200 may acquire the trained model A′ from the UE 100 and transmit the acquired trained model A′ to the model management entity MNE. The gNB 200 may transmit the trained model A′ by including the trained model A′ in a message available between the gNB 200 and the model management entity NNE and transmitting the message to the model management entity MINE. Alternatively, the gNB 200 may request the UE 100 to transmit the trained model A′ to the model management entity NNE. The request may be transmitted via a control message. In response to receiving the request, the UE 100 may transmit the trained model A′ to the model management entity NNE. In this case, the UE 100 may transmit the trained model A′ to the model management entity MINE using a message available between the UE 100 and the model management entity MINE (a NAS message when the model management entity MINE is the AMF 300). In response to receiving the trained model A′, the model management entity MINE may assign a new model ID and transmit the model ID to the gNB 200 (and the UE 100). At this time, the model management entity MINE may add the model ID for the trained model A′ to the management list.

In step S513, the UE 100 performs a process of acquiring a new model ID for the trained model A′. The UE 100 may acquire a new model ID by registering a new trained model with the model management entity MINE.

First, the UE 100 may acquire a new model ID by transmitting, to the model management entity MNE, a change flag-on notification indicating that model change information has been turned on. In this case, the model change information may include the model ID of the trained model A. The change flag-on notification may also be transmitted using a message available between the UE 100 and the model management entity MINE. In response to receiving the change flag-on notification, the model management entity NNE may assign a new model ID to the trained model A′ after re-training the trained model A and transmit the model ID to the UE 100. The model management entity NNE may turn on the model change information for the trained model A and add the model ID for the trained model A′ to the management list.

Second, the UE 100 may acquire anew model ID by transmitting a model ID acquisition request to the model management entity MINE to request the acquisition of a new model ID. The model ID acquisition request may include the model ID of the trained model A before re-training. The UE 100 may transmit, to the model management entity INE, a model ID acquisition request using a message available between the UE 100 and the model management entity MINE. In response to receiving the model ID acquisition request, the model management entity MNE may assign a new model ID and transmit the model ID to the UE 100. At this time, the model management entity MINE may turn on the model change information for the trained model A and add the model ID for the trained model A′ to the management list.

Third, the UE 100 may acquire a new model ID by transmitting the trained model A′ to the model management entity MNE. The gNB 200 may request the UE 100 to transmit the trained model A′ to the model management entity MNE. In response to receiving the request (control data), the UE 100 may transmit the trained model A′ to the model management entity MINE. The UE 100 may transmit, to the model management entity MINE, the trained model A′ using a message available between the UE 100 and the model management entity MNE. In response to receiving the trained model A′, the model management entity MNE may assign a new model ID and transmit the model ID to the UE 100. At this time, the model management entity MNE may add the model ID for the trained model A′ to the management list.

Fourth, the UE 100 may acquire, from the gNB 200, the new model ID (step S512) acquired by the gNB 200. The model ID may be transmitted using the control data.

Note that the gNB 200 may request the UE 100 (and/or the model management entity MINE) to turn off (or clear) the model change information for the new model ID (or to indicate that re-training has not been performed). For the trained model A′ after re-training, the model change information remains off until further re-training is performed. The request may also be transmitted using a control message (and/or a message available to and from the model management entity NINE).

In step S514, the UE 100 updates the model ID. That is, the UE 100 updates the model ID of trained model A′ to the newly acquired model ID (step S513). Thereafter, the UE 100 performs model inference using the trained model A′.

### Another Operation Example 1 According to First Embodiment

In the first embodiment, an example in which the reception entity RE is the gNB 200 has been described, but the reception entity RE may also be a core network apparatus. In this case, in the operation example in FIG. 17, the gNB 200 (reception entity RE) can be replaced with a core network apparatus. In the operation example in FIG. 17, between the UE 100 (transmission entity TE) and the core network apparatus (reception entity RE), transmission of a trained model (step S501), transmission of a switching notification (steps S502, S505, and S510), and the like may be performed using a message available between these apparatuses (e.g., a NAS message when the core network apparatus is the AMF 300). In the operation example in FIG. 17, a change flag-on notification (steps S507 and S512) or the like may also be transmitted between the core network apparatus (reception entity RE) and the model management entity MINE using a predetermined message (an NG message when the reception entity RE is the AMF 300 and the model management entity MNE is the gNB 200).

### Another Operation Example 2 According to First Embodiment

The reception entity RE may be an OTT server apparatus. In this case, in the operation example in FIG. 17, the gNB 200 (reception entity RE) can be replaced with an OTT server apparatus. In the operation example in FIG. 17, between the UE 100 (transmission entity TE) and the OTT server apparatus (reception entity RE), transmission of a trained model (step S501), transmission of a switching notification (steps S502, S505, and S510), and the like may be performed using a message available between the UE 100 and the OTT server apparatus. In the operation example in FIG. 17, a change flag-on notification (steps S507 and S512) or the like may also be transmitted between the OTT server apparatus (reception entity RE) and the model management entity MINE using a specific message available between these apparatuses.

### Another Operation Example 3 According to First Embodiment

In the first embodiment, an example has been described in which the transmission entity TE is the UE 100 and the reception entity RE is the gNB 200, but the present disclosure is not limited thereto. For example, the transmission entity TE may be the gNB 200 and the reception entity RE may be a core network apparatus.

In this case, in the operation example in FIG. 17, this can be implemented by replacing the UE 100 (transmission entity TE) with the gNB 200 and the gNB 200 (reception entity RE) with a core network apparatus. In the operation example in FIG. 17, between the gNB 200 (transmission entity TE) and the core network apparatus (reception entity RE), transmission of a trained model (step S501), transmission of a switching notification (steps S502, S505, and S510), and the like may be performed using a message available between the gNB 200 and the core network apparatus (e.g., an NG message when the core network apparatus is the AMF 300). In the operation example in FIG. 17, a change flag-on notification (steps S507 and S512) or the like may also be transmitted between the core network apparatus (reception entity) and the model management entity MINE using a specific message available between these apparatuses.

### Another Operation Example 4 According to First Embodiment

The transmission entity TE may be the gNB 200 and the reception entity RE may be an OTT server apparatus. In the operation example in FIG. 17, the UE 100 (transmission entity TE) can be replaced with the gNB 200 and the gNB 200 (reception entity RE) can be replaced with an OTT server apparatus. In this case, between the gNB 200 (transmission entity TE) and the OTT server apparatus (reception entity RE), transmission of a trained model (step S501), transmission of a switching notification (steps S502, S505, and S510), and the like may be performed using a specific message available between these apparatuses. In the operation example in FIG. 17, a change flag-on notification (steps S507 and S512) or the like may also be transmitted between the OTT server apparatus (reception entity RE) and the model management entity MINE using a specific message available between these apparatuses.

### Second Embodiment

A second embodiment will be described. In the second embodiment, differences from the first embodiment will mainly be described.

In the first embodiment, an example has been described in which the model change information is turned on in the transmission entity TE and the reception entity RE (steps S506 and S509) with the reception entity RE transmitting a switching notification to the training mode to the transmission entity TE as a trigger (step S505).

In the second embodiment, an example will be described in which the reception entity RE does not transmit the switching notification, and the transmission entity TE re-trains the trained model and turns on the model change information by its own determination.

Specifically, first, the transmission entity (e.g., the UE 100) performs model inference using a trained first AI/ML model (e.g., a trained model A). Second, the transmission entity performs model training of the first AI/ML model based on the inference result of the model inference. Third, the transmission entity turns on the model change information. Fourth, the transmission entity transmits a training execution notification to the reception entity (e.g., the gNB 200) indicating that model training of the first AI/ML model has been performed. Fifth, the reception entity turns on the model change information in response to receiving the training execution notification.

In this way, also in the second embodiment, both the transmission entity TE and the reception entity RE can turn on the model change information when the trained model A is re-trained. This makes it possible, for example, in the mobile communication system 1 to ascertain whether the trained model A is a model that has been re-trained. Therefore, in the mobile communication system 1, it is possible to appropriately manage the AI/ML model.

### Operation Example According to Second Embodiment

An operation example according to the second embodiment will be described.

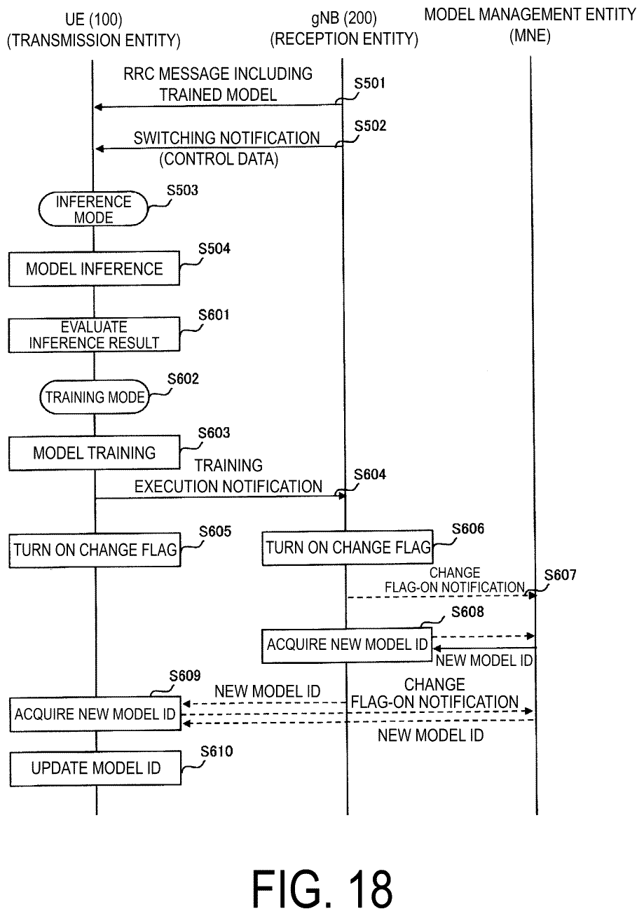

FIG. 18 is a diagram illustrating the operation example according to the second embodiment. Similarly to the first embodiment, the operation example illustrated in FIG. 18 also represents an example in which the transmission entity TE is the UE 100, the reception entity RE is the gNB 200, and the model management entity MINE is a core network apparatus. Also in FIG. 18, the trained model to be re-trained will be described as a trained model A. Also in FIG. 18, processing in the UE 100 may be performed by the controller 130, and processing in the gNB 200 may be performed by the controller 230.

As illustrated in FIG. 18, steps S501 to S504 are the same operations as those in the first embodiment.

In step S601, the UE 100 evaluates the inference result of the model inference (step S504) of the trained model received in step S501.

First, the UE 100 may evaluate the inference results by comparison with a legacy operation. For example, during model inference, the UE 100 performs a legacy operation that does not use an AI/MWL model, and acquires operation result data. Then, the UE 100 may compare the operation result data with inference result data based on the model inference, and evaluate the inference result. The UE 100 may determine that re-training of the trained model A is not necessary if a difference between the operation result data and the inference result data is within a threshold value, and the UE 100 may determine that re-training is necessary if not.

Second, the UE 100 may evaluate the inference result by performing a likelihood determination on the inference result data. Specifically, the UE 100 may apply a likelihood function to inference result data at a certain timing, compare it with inference result data immediately before that timing, and evaluate the inference result. For example, the UE 100 may determine that re-training of the trained model A is not necessary if a difference between the data to which the likelihood function has been applied and the inference result data is within a threshold value, and the UE 100 may determine that re-training is necessary if not.

In this way, the UE 100 determines whether re-training of the trained model A is necessary based on the inference result of model inference using the trained model A. In the following description, it is assumed that the UE 100 has determined that re-training of the trained model is necessary as a result of evaluating the inference result.

In step S602, the UE 100 switches to the training mode. The UE 100 may use control data to transmit, to the gNB 200, a notification indicating that the training mode will be switched.

In step S603, the UE 100 performs model training (i.e., re-training) on the trained model A.

In step S604, the UE 100 transmits, to the gNB 200, a training execution notification indicating that re-training of the trained model A has been performed. The UE 100 may transmit the training execution notification by transmitting an RRC message including the training execution notification. Alternatively, when a new layer is defined for performing or controlling machine learning processing (AI/MWL processing), the UE 100 may transmit a training execution notification by including the training execution notification in a message of the new layer and transmitting the message. The gNB 200 receives the training execution notification.

In step S605, the UE 100 turns on the model change information of the trained model A. Alternatively, the UE 100 may turn on the model change information of the trained model A in response to receiving, from the gNB 200, configuration information indicating that the model change information is to be turned on. The UE 100 may transmit, to the model management entity MNE, a change flag-on notification indicating that the model change information has been turned on.

In step S606, in response to receiving the training execution notification, the gNB 200 turns on the model change information of the trained model A. In step S607, the gNB 200 may transmit, to the model management entity MNE, a change flag-on notification indicating that the model change information of the trained model has been turned on.

The subsequent steps S608 to S610 are the same as steps S512 to S514 in the first embodiment, respectively.

### Another Operation Example 1 according to Second Embodiment

In the second embodiment, an example in which the reception entity RE is the gNB 200 has been described, but the reception entity RE may also be a core network apparatus. In this case, in the operation example in FIG. 18, the gNB 200 (reception entity) can be replaced with a core network apparatus. In the operation example in FIG. 18, transmission of a trained model (step S501), transmission of a switching notification (step S502), and the like may be performed using a message available between the UE 100 and the core network apparatus (e.g., a NAS message when the core network apparatus is the AMF 300). In the operation example in FIG. 18, a change flag-on notification (steps S607 and S608) or the like may also be transmitted between the core network apparatus (reception entity RE) and the model management entity MNE using a predetermined message (an NG message when the reception entity RE is the AMF 300 and the model management entity MINE is the gNB 200).

### Another Operation Example 2 According to Second Embodiment

The reception entity RE may be an OTT server apparatus. In this case, in the operation example in FIG. 18, the gNB 200 (reception entity RE) can be replaced with an OTT server apparatus. In the operation example in FIG. 18, between the UE 100 and the OTT server apparatus (reception entity RE), transmission of a trained model (step S501), transmission of a switching notification (step S502), and the like may be performed using a message available between the UE 100 and the OTT server apparatus. In the operation example in FIG. 18, a change flag-on notification (steps S607 and S608) or the like may also be transmitted between the OTT server apparatus (reception entity RE) and the model management entity MNE using a specific message available between these apparatuses.

### Another Operation Example 3 According to Second Embodiment

In the second embodiment, an example has been described in which the transmission entity TE is the UE 100 and the reception entity RE is the gNB 200, but the present disclosure is not limited thereto. For example, the transmission entity TE may be the gNB 200 and the reception entity RE may be a core network apparatus.

In this case, in the operation example in FIG. 18, this can be implemented by replacing the UE 100 (transmission entity TE) with the gNB 200 and the gNB 200 (reception entity RE) with a core network apparatus. In the operation example in FIG. 18, between the gNB 200 (transmission entity TE) and the core network apparatus (reception entity RE), transmission of a trained model (step S501), transmission of a switching notification (step S502), and the like may be performed using a message available between the gNB 200 and the core network apparatus (e.g., an NG message when the core network apparatus is the AMF 300). In the operation example in FIG. 18, a change flag-on notification (steps S607 and S608) or the like may also be transmitted between the core network apparatus (reception entity) and the model management entity MINE using a specific message available between these apparatuses.

### Another Operation Example 4 According to Second Embodiment

The transmission entity TE may be the gNB 200 and the reception entity RE may be an OTT server apparatus. In this case, in the operation example in FIG. 18, the UE 100 (transmission entity TE) can be replaced with the gNB 200, and the gNB 200 (reception entity RE) can be replaced with an OTT server apparatus. Between the gNB 200 (transmission entity TE) and the OTT server apparatus (reception entity RE), transmission of a trained model (step S501), transmission of a switching notification (step S502), and the like may be performed using a specific message available between these apparatuses. In the operation example in FIG. 18, a change flag-on notification (steps S607 and S608) or the like may also be transmitted between the OTT server apparatus (reception entity RE) and the model management entity MINE using a specific message available between these apparatuses.

### Third Embodiment

A third embodiment will be described. In the third embodiment, differences from the first and second embodiments will mainly be described.

In the first embodiment, an example has been described in which the model change information is turned on (steps S506 and S509) with the reception entity RE transmitting a switching notification to the training mode as a trigger (step S505 in FIG. 17). In the second embodiment, an example has been described in which the transmission entity TE evaluates the inference result (step S601 in FIG. 18) without receiving the switching notification, re-trains the trained model, and turns on the model change information (steps S601 to S606 in FIG. 18).

In the third embodiment, an example will be described in which the reception entity RE evaluates the inference results of the model inference performed by the transmission entity TE and causes the transmission entity TE to re-train the trained model.

Specifically, first, the transmission entity (e.g., the UE 100) performs model inference using a first AI/ML model. Second, the transmission entity transmits inference result data indicating the inference result of the model inference to the reception entity (e.g., the gNB 200). Third, the reception entity transmits, to the transmission entity, a switching notification to start training of the first AI/ML model based on the inference result data. Fourth, the reception entity turns on the model change information in response to transmitting the switching notification. Fifth, in response to receiving the switching notification, the transmission entity re-trains the first AI/ML model and turns on the model change information.

In the third embodiment, similarly to the second embodiment, when the trained model A is re-trained, both the transmission entity TE and the reception entity RE can turn on the model change information. This makes it possible, for example, in the mobile communication system 1 to easily ascertain whether the trained model A is a trained model that has been re-trained. Therefore, in the mobile communication system 1, it is possible to appropriately manage the AI/ML model.

### Operation Example According to Third Embodiment

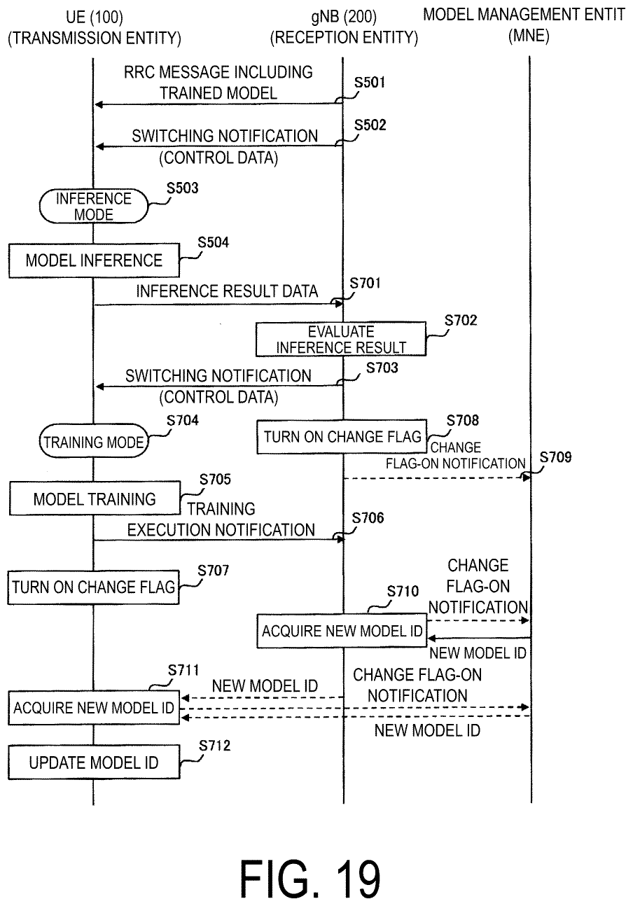

FIG. 19 is a diagram illustrating an operation example according to the third embodiment. Similarly to the first embodiment, the operation example illustrated in FIG. 19 also represents an example in which the transmission entity TE is the UE 100, the reception entity RE is the gNB 200, and the model management entity MINE is a core network apparatus. Also in FIG. 19, the trained model to be re-trained will be described as a trained model A. In FIG. 19, processing in the UE 100 may be performed by the controller 130, and processing in the gNB 200 may be performed by the controller 230.

Steps S501 to S504 are the same as those in the first embodiment.

In step S701, the UE 100 transmits the inference result data for the trained model A received in step S501 to the gNB 200. The inference result data may also be transmitted using an RRC message or a new message for machine learning processing (AI/ML processing), similarly to the training execution notification (step S604 in FIG. 18).

In step S702, the gNB 200 evaluates the inference result. The method for evaluating the inference result itself may be the same as that in the second embodiment (step S601 in FIG. 18). When the gNB 200 evaluates the inference result by comparison with a legacy operation, the gNB 200 may compare the inference result with operation result data from a legacy operation received from other UEs under the same conditions as the UE 100 (or at the same timing as the inference). In the following description, it is assumed that the gNB 200 has determined that re-training of the trained model A is necessary as a result of the evaluation.

In step S703, the gNB 200 transmits, to the UE 100, a switching notification for switching from the inference mode to the training mode. Based on the inference result data (step S701), the gNB 200 transmits, to the UE 100, a switching notification to start training (i.e., re-training) of the trained model A.

In response to receiving the switching notification, the UE 100 switches to training mode (step S704), performs model training (i.e., re-training) for the trained model A (step S707), and transmits a training execution notification to the gNB 200 (step S706).

Then, in step S707, the UE 100 turns on the model change information for the trained model A.

Meanwhile, in step S708, the gNB 200 turns on the model change information of the trained model A in response to transmitting the switching notification (step S703). In step S709, the gNB 200 may transmit a change flag-on notification to the model management entity MNE.

The subsequent steps S710 to S712 are the same as steps S512 to S514 in the first embodiment, respectively.

### Another Operation Example 1 According to Third Embodiment

In the third embodiment, an example in which the reception entity RE is the gNB 200 has been described. The reception entity RE may be a core network apparatus. In this case, in the operation example in FIG. 19, the gNB 200 (reception entity RE) can be replaced with a core network apparatus. In the operation example in FIG. 19, transmission of a trained model (step S501), transmission of a switching notification (step S502), and the like may be performed using a message available between the UE 100 and the core network apparatus (e.g., a NAS message when the core network apparatus is the AMF 300). In the operation example in FIG. 19, a change flag-on notification (steps S709 and 710) may also be transmitted between the core network apparatus (reception entity RE) and the model management entity MINE using a predetermined message (an NG message when the reception entity RE is the AMF 300 and the model management entity MINE is the gNB 200).

### Another Operation Example 2 According to Third Embodiment

The reception entity RE may be an OTT server apparatus. In this case, in the operation example in FIG. 19, the gNB 200 (reception entity RE) can be replaced with an OTT server apparatus. In the operation example in FIG. 19, between the UE 100 and the OTT server apparatus (reception entity RE), transmission of a trained model (step S501), transmission of a switching notification (step S502), and the like may be performed using a message available between the UE 100 and the OTT server apparatus. In the operation example in FIG. 19, a change flag-on notification (steps S709 and S710) may also be transmitted between the OTT server apparatus (reception entity RE) and the model management entity MNE using a specific message available between these apparatuses.

### Another Operation Example 3 According to Third Embodiment

In the third embodiment, an example has been described in which the transmission entity TE is the UE 100 and the reception entity RE is the gNB 200, but the present disclosure is not limited thereto. For example, the transmission entity TE may be the gNB 200 and the reception entity RE may be a core network apparatus.

In this case, in the operation example in FIG. 19, this can be implemented by replacing the UE 100 (transmission entity TE) with the gNB 200 and the gNB 200 (reception entity RE) with a core network apparatus. In the operation example in FIG. 19, between the gNB 200 (transmission entity TE) and the core network apparatus (reception entity RE), transmission of a trained model (step S501), transmission of a switching notification (step S502), and the like may be performed using a message available between the gNB 200 and the core network apparatus (e.g., an NG message when the core network apparatus is the AMF 300). In the operation example in FIG. 19, a change flag-on notification (steps S709 and S710) may also be transmitted between the core network apparatus (reception entity) and the model management entity MINE using a specific message available between these apparatuses.

### Another Operation Example 4 According to Third Embodiment

The transmission entity TE may be the gNB 200 and the reception entity RE may be an OTT server apparatus. In this case, in the operation example in FIG. 19, the UE 100 (transmission entity TE) can be replaced with the gNB 200, and the gNB 200 (reception entity RE) can be replaced with an OTT server apparatus. Between the gNB 200 (transmission entity TE) and the OTT server apparatus (reception entity RE), transmission of a trained model (step S501), transmission of a switching notification (step S502), and the like may be performed using a specific message available between these apparatuses. In the operation example in FIG. 19, a change flag-on notification (steps S709 and S710) may also be transmitted between the OTT server apparatus (reception entity RE) and the model management entity MNE using a specific message available between these apparatuses.

### Other Embodiments

In the above-mentioned second and third embodiments, an example has been described in which a training execution notification (steps S604 and S706) is notified using an RRC message between the UE 100 and the gNB 200, but the present disclosure is not limited thereto. When a new layer for performing or controlling the machine learning processing (AI/ML processing) is defined, a message of the new layer may be used instead of an RRC message. This message of the new layer may also be used for notifications between the UE 100 and the gNB 200 in the first to third embodiments.

In the first to third embodiments described above, the supervised learning has mainly been described. However, the present disclosure is not limited thereto. For example, unsupervised learning or reinforcement learning may be applied to the first to third embodiments.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, but may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs, a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise”, and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

A program (e.g., information processing program) for causing a computer to execute each process or each function according to the above-described embodiment may be provided. A program (e.g., mobile communication program) may be provided that causes the mobile communication system 1 to execute each of the processing operations or each of the functions according to the embodiments described above. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

The embodiments have been described above in detail with reference to the drawings, but specific configurations are not limited to those described above, and various design variation can be made without departing from the gist of the present disclosure. It is also possible to combine each embodiment, each operation example, each process, and the like without contradicting.

### Supplementary Notes

### (Supplementary Note 1)

A communication control method in a mobile communication system (e.g., a mobile communication system 1), the communication control method including:
managing, by a model management entity (e.g., a model management entity MNE), model change information indicating whether model training has been performed on a trained first AI/IL model.
   (Supplementary Note 2) The communication control method according to Supplementary note 1, in which the model change information is included in any one of model identification information identifying the first AI/ML model, additional information added to the first AI/ML model, or the first AI/ML model.

### (Supplementary Note 3)

The communication control method according to Supplementary note 1 or 2, further including the steps of:
transmitting, by a reception entity (e.g., a reception entity RE) to a transmission entity (e.g., a transmission entity TE), a switching notification to start training of the first AI/ML model; turning on, by the reception entity, the model change information, in response to transmitting the switching notification; and
by the transmission entity, performing model training of the first AI/ML model and turning on the model change information, in response to receiving the switching notification.

### (Supplementary Note 4)

The communication control method according to any one of Supplementary notes 1 to 3, further including the steps of:
performing, by a transmission entity, model inference using the first AI/ML model; performing, by the transmission entity, model training of the first AI/ML model based on an inference result of the model inference;
turning on, by the transmission entity, the model change information;
transmitting, by the transmission entity to a reception entity, a training execution notification indicating that model training of the first AI/ML model has been performed; and
turning on, by the reception entity, the model change information, in response to receiving the training execution notification.

### (Supplementary Note 5)

The communication control method according to any one of Supplementary notes 1 to 4, further including the steps of:
performing, by a transmission entity, model inference using the first AI/ML model; transmitting, by the transmission entity to a reception entity, inference result data indicating an inference result of the model inference;
transmitting, by the reception entity to the transmission entity, a switching notification to start training of the first AI/ML model based on the inference result data;
turning on, by the reception entity, the model change information, in response to transmitting the switching notification; and
by the transmission entity, performing model training of the first AI/ML model and turning on the model change information, in response to receiving the switching notification.

### (Supplementary Note 6)

The communication control method according to any one of Supplementary notes 1 to 5, further including:
transmitting, by the reception entity to the model management entity, a change flag-on notification indicating that the model change information of the first AI/ML model has been turned on; and/or
transmitting, by the transmission entity to the model management entity, a change flag-on notification indicating that the model change information of the first AI/ML model has been turned on.

### (Supplementary Note 7)

The communication control method according to any one of Supplementary notes 1 to 6, further including:
transmitting, by the model management entity to the reception entity and the transmission entity, new model identification information for a second AI/ML model after model training of the first AI/ML model, in response to receiving the change flag-on notification.

### (Supplementary Note 8)

A user equipment including:
a controller configured to turn on, when model training is performed on a trained first AI/ML model, model change information indicating whether model training has been performed on the first AI/ML model.

### REFERENCE SIGNS

1: Mobile communication system
20: 5GC (CN)
100: UE
110: Receiver
120: Transmitter
130: Controller
200: gNB
210: Transmitter
220: Receiver
230: Controller
A1: Data collector
A2: Model trainer
A3: Model inferrer
A4: Data processor
TE: Transmission entity
RE: Reception entity
MNE: Model management entity

1. A communication control method in a mobile communication system, the communication control method comprising:
managing, by a model management entity, model change information indicating whether model training has been performed on a trained first artificial intelligence (AJ)/machine learning (ML) model.

2. The communication control method according to claim 1, wherein the model change information is included in any one of model identification information identifying the first AI/ML model, additional information added to the first AI/ML model, or the first AI/ML model.

3. The communication control method according to claim 1, further comprising:
transmitting, by a reception entity to a transmission entity, a switching notification to start training of the first AI/ML model;
turning on, by the reception entity, the model change information, in response to transmitting the switching notification; and
by the transmission entity, performing model training of the first AI/ML model and turning on the model change information, in response to receiving the switching notification.

4. The communication control method according to claim 1, further comprising:
performing, by a transmission entity, model inference using the first AI/ML model;
performing, by the transmission entity, model training of the first AI/ML model based on an inference result of the model inference;
turning on, by the transmission entity, the model change information;
transmitting, by the transmission entity to a reception entity, a training execution notification indicating that model training of the first AI/ML model has been performed; and
turning on, by the reception entity, the model change information, in response to receiving the training execution notification.

5. The communication control method according to claim 1, further comprising:
performing, by a transmission entity, model inference using the first AI/ML model;
transmitting, by the transmission entity to a reception entity, inference result data indicating an inference result of the model inference;
transmitting, by the reception entity to the transmission entity, a switching notification to start training of the first AI/ML model based on the inference result data;
turning on, by the reception entity, the model change information, in response to transmitting the switching notification; and
by the transmission entity, performing model training of the first AI/ML model and turning on the model change information, in response to receiving the switching notification.

6. The communication control method according to claim 3, further comprising:
transmitting, by the reception entity to the model management entity, a change flag-on notification indicating that the model change information of the first AI/ML model has been turned on; and/or
transmitting, by the transmission entity to the model management entity, a change flag-on notification indicating that the model change information of the first AI/ML model has been turned on.

7. The communication control method according to claim 6, further comprising:
transmitting, by the model management entity to the reception entity and the transmission entity, new model identification information for a second AI/ML model after model training of the first AI/ML model, in response to receiving the change flag-on notification.

8. A user equipment comprising:
a controller configured to turn on, when model training is performed on a trained first AI/ML model, model change information indicating whether model training has been performed on the first AI/ML model.
